(19) United States
(12) Patent Application Publication
(10) Pub. No.: US 2017/0307470 A1
(43) Pub. Date: Oct. 26, 2017

(54) LIGHTING JIG

(71) Applicants: BOE TECHNOLOGY GROUP CO., LTD., Beijing (CN); HEFEI XINSHENG OPTOELECTRONICS TECHNOLOGY CO., LTD., Hefei City, Anhui (CN)

(72) Inventors: Lei MAO, Beijing (CN); Yi YANG, Beijing (CN); Wei DAI, Beijing (CN); Yubao LU, Beijing (CN)

(73) Assignees: BOE TECHNOLOGY GROUP CO., LTD., Beijing (CN); HEFEI XINSHENG OPTOELECTRONICS TECHNOLOGY CO.,LTD, Hefei City, Anhui (CN)

(21) Appl. No.: 15/526,150

(22) PCT Filed: Oct. 18, 2016
(86) PCT No.: PCT/CN2016/102342

§ 371 Date: May 11, 2017

(30) Foreign Application Priority Data
Oct. 26, 2015 (CN) 201520837468.6

(51) Int. Cl. G01M 11/04

(52) U.S. Cl. CPC G01M 11/04

(57) ABSTRACT

A lighting jig. The lighting jig includes: a tray, a support frame, and an angle adjusting mechanism. The tray is movably connected to the support frame via the angle adjusting mechanism. The tray is configured to carry a display panel, and the support frame is configured to support the tray. The lighting jig addresses the problem of a complicated test process of a display panel, thus simplifying the test process of the display panel.

### TECHNICAL FIELD

Embodiments of the present disclosure relate to a lighting jig.

### BACKGROUND

With the popularity of smart phones, tablet PCs and other electronic devices, users have an increasing display requirement about the display panels applied to these electronic devices. In the manufacturing process of a display panel, the display panel is required to be lighted (being powered on to display) for detection, to ensure the quality of the display panel. The display panel can usually be fixed onto a lighting jig, and a signal is applied to the display panel to light up the display panel, and then a staff would view the display panel from different perspectives, so as to detect bright spots, black spots, foreign matters and the like at the display panel.

The lighting jig usually includes a tray for carrying the display panel and a support frame for supporting the tray, and the tray is fixedly connected to the support frame. When the display panel is detected, the lighting jig is placed onto a work table by means of the support frame, the display panel is arranged on the tray and is lighted up, and then the staff changes the relative position between himself/herself and the tray by moving his/her own position to vary the viewing angle and then to view the display panel from different perspectives.

### SUMMARY

Embodiments of present disclosure provide a lighting jig which is capable of solving the current problem that the detection process of the display panel is complicated.

At least one embodiment of the present disclosure provides a lighting jig which includes a tray, a support frame and an angle adjusting mechanism, the tray is in a movable connection with the support frame by means of the angle adjusting mechanism, the tray is configured to carry a display panel, and the support frame is configured to support the tray.

For example, in the lighting jig provided by all embodiment of the present disclosure, the angle adjusting mechanism includes a connecting rod and a sphere which is fixedly connected with an end of the connecting rod, the other end of the connecting rod is connected with the tray, a concave is provided in the support frame, the sphere is provided in the concave and contacts an inner wall of the concave, and the tray is rotatable around the support frame.

For example, the lighting jig provided by an embodiment of the present disclosure further includes a lock mechanism located at the support frame, in a case that the lock mechanism is released, the sphere is configured to be able to move within the concave; and in a case that the lock mechanism is locked, the sphere is configured to be fixed in the concave.

For example, in the lighting jig provided by an embodiment of the present disclosure, the lock mechanism includes at least two first bolts, the support frame comprises a columnar structure, a lateral side of the support frame is provided with at least two first screw holes communicating with the concave, and each of the first bolts is configured to be able to pass through one of the first screw holes to fix the sphere.

For example, in the lighting jig provided by an embodiment of the present disclosure, in the case that the lock mechanism is locked, movement directions of at least two of the first bolts are different from each other.

For example, in the lighting jig provided by an embodiment of the present disclosure, the concave is a concave with a curved surface.

For example, in the lighting jig provided by an embodiment of the present disclosure, the support frame includes a first cylindrical structure and a second cylindrical structure, a cavity is provided ill the first cylindrical structure, the second cylindrical structure is provided at least partially within the cavity, one bottom surface of the second cylindrical structure is provided within the cavity, and the other bottom surface of the second cylindrical structure is provided with the concave.

For example, the lighting jig provided by an embodiment of the present disclosure further includes a height adjusting mechanism, and the height adjusting mechanism is provided at the support frame for adjustment of a height of the support frame.

For example, in the lighting jig provided by an embodiment of the present disclosure, the height adjusting mechanism includes a second bolt, at least two second screw holes are provided at a lateral side of the second cylindrical structure in a height direction of the support frame, a third screw hole is provided at a lateral side of the first cylindrical structure, and the second bolt is configured to be able to pass through the third screw hole and one of the second screw holes sequentially, so as to fixedly connect the first cylindrical structure and the second cylindrical structure.

For example, in the lighting jig provided by an embodiment of the present disclosure, extending directions of the second screw holes and the third screw hole are orthogonal to the height direction of the support frame.

For example, in the lighting jig provided by an embodiment of the present disclosure, a carrying surface, configured for carrying the display panel, of the tray is provided with a catching structure configured for catching the display panel.

For example, in the lighting jig provided by an embodiment of the present disclosure, the catching structure includes at least two stoppers, and the stoppers include a stationary stopper and a movable stopper.

For example, in the lighting jig provided by an embodiment of the present disclosure, the catching structure includes two stationary stoppers and one movable stopper, and length directions of the two stationary stoppers are perpendicular to each other, and a length direction of the movable stopper is perpendicular to a length direction of one of the stationary stoppers.

For example, in the lighting jig provided by an embodiment of the present disclosure, any adjacent two catching structures share one of the stationary stoppers.

For example, in the lighting jig provided by an embodiment of the present disclosure, each of the stationary stoppers and the movable stopper is provided, at a location which is configured to be in contact with the display panel, with a rubber pad.

For example, in the lighting jig provided by an embodiment of the present disclosure, the carrying surface is provided with a slide rail along which the movable stopper is movable.

For example, the lighting jig provided by an embodiment of the present disclosure further includes a third bolt, the movable stopper is provided with a fourth screw hole, a bottom of the slide rail is provided with a through hole extending along a thickness direction of the tray, and the third bolt is able to pass through the fourth screw hole and the through hole to connect the slide rail and the movable stopper.

For example, the lighting jig provided by an embodiment of the present disclosure further includes a support bar, one end of the support bar is fixedly connected to the tray, and the other end is fixedly connected to a lateral side of the support frame.

For example, in the lighting jig provided by an embodiment of the present disclosure, the sphere is a rigid sphere, and the connecting rod is integral with the sphere.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure; and other drawings can also be obtained according to these drawings by a person skilled in the art without any inventive work.

FIG. 1 is a view of an application scenario of a lighting jig;

FIG. 2 is a structural schematic view of a lighting jig provided in an embodiment of the present disclosure;

FIG. 3 is a structural schematic view of a lighting jig provided in another embodiment of the present disclosure;

FIG. 4 is a structural schematic view of a first cylindrical structure provided in the embodiment shown in FIG. 3;

FIG. 5 is a structural schematic view of a second cylindrical structure provided in the embodiment shown in FIG. 3;

FIG. 6 is a front view of a tray provided by the embodiment shown in FIG. 3; and

FIG. 7 is a front view of a tray carrying a display panel provided in the embodiment shown in FIG. 3.

### DETAILED DESCRIPTION

In order to make objects, technical details and advantages of the embodiments of the disclosure apparent, the embodiments of present disclosure will be described in connection with the drawings. Apparently, the described embodiments are just a part but not all of the embodiments of the disclosure. Based on the described embodiments herein, those skilled in the art can obtain other embodiment(s), without any inventive work, which should be within the scope of the disclosure.

FIG. 1 is a view of an application scenario of a lighting jig 01, as shown in FIG. 1, the lighting jig 01 includes a tray 011 for carrying a display panel A and a support frame 012 for supporting the tray 011, and the tray 011 is fixedly connected to the support frame 012. When the display panel A is detected, the lighting jig 01 is placed onto a work table 00 (the work table 00 may be provided in a form of desktop) by means of the support frame 012, and the display panel A is arranged onto the tray 011 and is lighted up. A staff changes the relative position between himself/herself and the tray 011 by moving his/her own position to vary the viewing angle, and thus to view the display panel A from different perspectives. Due to the need for the staff to move his/her own position, the detection process of the display panel is complicated. In the lighting jig shown in FIG. 1, the height of the support frame 012 is fixed, and artificial error may occur in the detection process, for example, due to the height deviation among staffs, there may be differences in the detection results because of the difference between the heights of the staffs.

To solve the above problem, the embodiments of present disclosure provide a lighting jig, which includes a tray, a support frame and an angle adjusting mechanism, and the tray is in a movable connection with the support frame by means of the angle adjusting mechanism; and the tray is configured to carry the display panel, and the support frame is configured to support the tray. Due to the movable connection of the tray with the support frame by means of the angle adjusting mechanism, it is possible to adjust the angle of the tray by means of the angle adjusting mechanism without the need that the staff moves his/her own position. Therefore, the lighting jig provided by the embodiments of present disclosure solves the problem that the current detection process of the display panel is complicated, and achieves a beneficial effect of simplifying the detection process of the display panel.

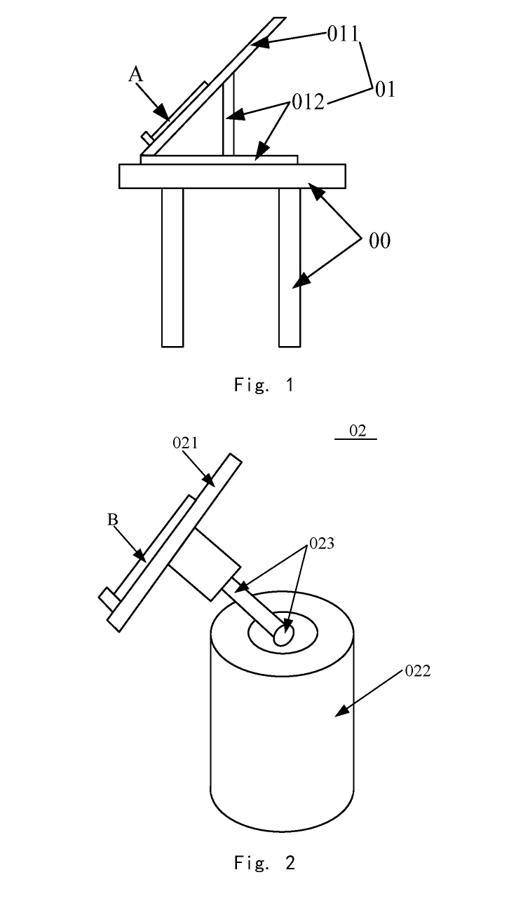

Referring to FIG. 2, which illustrates a structural schematic view of a lighting jig 02 provided in one embodiment of the present disclosure, the lighting jig 02 may be used to detect the display panel, such as, to detect the bright spots, the black spots, the foreign matters and the like on the display panel.

As shown in FIG. 2, the lighting jig 02 may include a tray 021, a support frame 022 and an angle adjusting mechanism 023. The tray 021 is in a movable connection with the support frame 022 by means of the angle adjusting mechanism 023, and the angle adjusting mechanism 023 may be used to adjust the angle of the tray 021; the tray 021 is configured to carry the display panel B, and the support frame 022 is configured to support the tray 021. As shown in this figure, in a case that the lighting jig is in an operation state, the tray 021 is disposed obliquely with respect to the horizontal direction, so as to facilitate an operator to view the display panel placed on the tray 021.

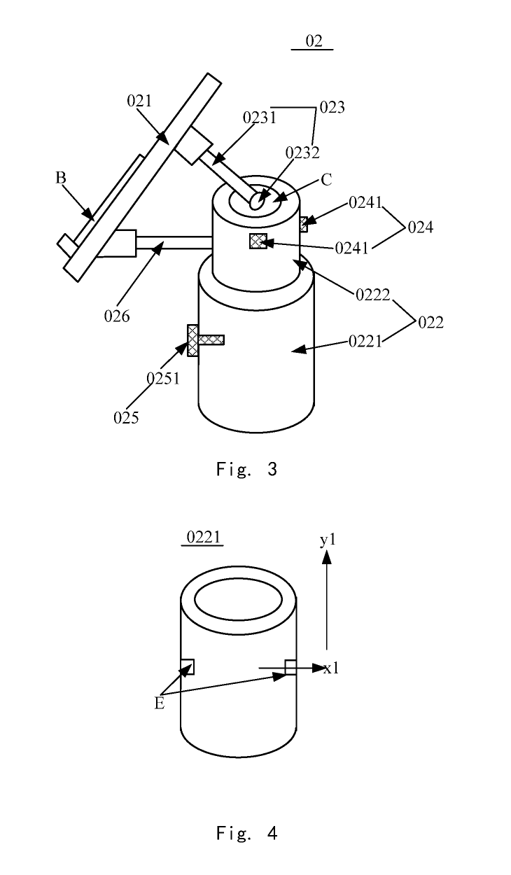

For example, FIG. 3 is a structural schematic view of a lighting jig 02 provided in another embodiment of the present disclosure, such a lighting jig 02 may be used to detect a display panel, for example, to detect bright spots, black spots, foreign matters and the like at the display panel.

As shown in FIG. 3, the lighting jig 02 may include a tray 021, a support frame 022 and an angle adjusting mechanism 023, the tray 021 is in a movable connection with the support frame 022 by means of the angle adjusting mechanism 023, the tray 021 is configured to carry the display panel B, and the support frame 022 is configured to support the tray 021.

For example, as shown in FIG. 3, the angle adjusting mechanism 023 may further include a connecting rod 0231 and a sphere 0232 fixedly connected to one end of the connecting rod 0231, and the other end of the connecting rod 0231 is connected with the tray 021, the support frame 022 is provided with a concave C in which the sphere 0232 is arranged, and the sphere 0232 is in contact with an the inner wall of the concave C, hence forming, for example, an universal spherical joint structure, and the tray is rotable around the axis of the support frame by means of the angle adjusting mechanism.

For example, as shown in FIG. 3, the lighting jig 02 further includes a lock mechanism 024 with which the sphere 0232 is in contact. When the lock mechanism 024 is released, the sphere 0232 is movable within the concave C; and when the lock mechanism 024 is locked, the sphere 0232 is fixed within the concave C. For example, the sphere 0232 may be a rigid sphere, and the connecting rod 0231 may be integral with the sphere 0232, in this way, it is possible to enhance the rigidity of the angle adjusting mechanism 023. The concave C may be a curved concave (a concave with a curved surface), thus it is possible to facilitate the movement of the sphere 0232 in the concave C.

For example, the lock mechanism 024 may further include at least two first bolts 0241, the support frame 022 may comprise a columnar structure, and a lateral side of the support frame 022 is provided with at least two first screw holes (not shown in FIG. 3) communicating with the concave C, each of the at least two first bolts 0241 is able to pass through one of the first screw holes and to press against the sphere 0232 within the concave C, in this way, when a plurality of first bolts 0241 having different extending directions presses against the sphere 0232 at the same time, the sphere can be fixed. In the process of locking the lock mechanism 024 in FIG. 3, the movement directions of the at least two first bolts 0241 are distinct.

For example, the support frame 022 may include a first cylindrical structure 0221 and a second cylindrical structure 0222, the first cylindrical structure 0221 is provided therein with a cavity (not shown in FIG. 3), the second cylindrical structure 0222 is fixedly arranged in the cavity of the first cylindrical structure 0221, one bottom surface of the second cylindrical structure 0222 is disposed in the cavity of the first cylindrical structure 0221, and the other bottom surface of the second cylindrical structure 0222 is provided with the concave C.

For example, the lighting jig 02 may further include a height adjusting mechanism 025, the height adjustment mechanism 025 is provided at the support frame 022 for the adjustment of the height of the support frame 022. In this way, the lighting jig 02 is enabled to eliminate artificial errors (for example, to eliminate errors in the detection results of the staffs having different heights).

For example, as shown in FIG. 3, the height adjusting mechanism 025 includes a second bolt 0251. A lateral side of the second cylindrical structure 0222 is provided with at least two second screw holes (not shown in FIG. 3) along the height direction of the support frame 022, and a lateral side of the first cylindrical structure 0221 is provided with at least two third screw holes (not shown in FIG. 3) along the height direction of the second cylindrical structure 0222, and the second bolt 0251 is able to pass through one of the third screw holes and arbitrary one of the second screw holes sequentially, so as to fixedly connect the first cylindrical structure 0221 and the second cylindrical structure 0222. For example, each of the second screw holes and each of the third screw holes have their extending directions perpendicular to the height direction of the second cylindrical structure 0222.

As an example and also as shown in FIG. 4 which is a structural schematic view of a first cylindrical structure 0221 provided in the embodiment shown in FIG. 3, see FIG. 4, the lateral side of the first cylindrical structure 0221 is provided with a third screw hole E. The number of the third screw hole E may be one or more, and the embodiment of present disclosure is not limited thereto. For example, as shown in FIG. 4, the number of the third screw holes E may be two. The two third screw holes E are symmetrically disposed at the lateral side of the first cylindrical structure 0221 with the axial sectional plane of the first cylindrical structure 0221 as the symmetrical plane, and the axis x1 of each third screw hole E may be perpendicular to the height direction y1.

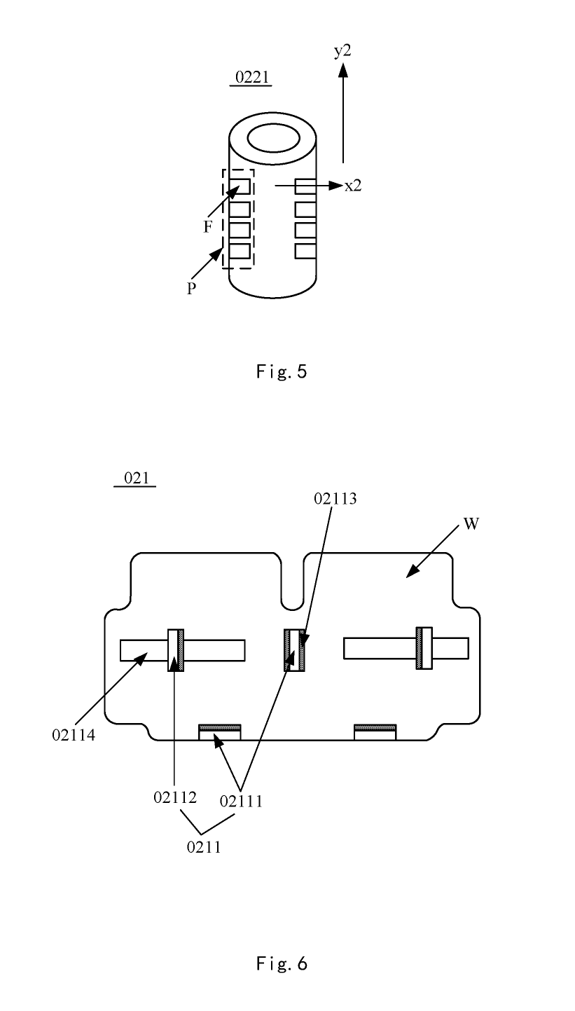

As an example and also referring to FIG. 5 which illustrates a structural schematic view of a second cylindrical structure 0222 provided in the embodiment shown in FIG. 3, see FIG. 5, the lateral side of the second cylindrical structure 0222 is provided with at least two second screw holes F along the height direction y2 of the second cylindrical structure 0222, and each of the second screw holes F has its axis x2 perpendicular to the height direction y2 of the second cylindrical structure 0222. It should be noted that, in practical situations, according to the difference in the positions and numbers of the third screw hole E at the first cylindrical structure 0221, the lateral side of the second cylindrical structure 0222 may be provided with a plurality of groups of screw holes P along the height direction y2 of the second cylindrical structure 0222, each of the groups of screw holes P includes at least two second screw holes F, the aperture of the second screw hole F may be equal to that of the third screw hole E, and the apertures of the second screw hole F and the third screw hole E are greater than the diameter of the screw rod of the second bolt 0251, so that the second bolt 0251 can pass through the third screw hole E and arbitrary one of the second screw holes F sequentially, so as to fixedly connect the first cylindrical structure 0221 and the second cylindrical structure 0222.

For example, as shown in FIG. 3, at least two catching structures (not shown in FIG. 3) is provided at the carrying surface, configured to carry the display panel, of the tray 021, such a catching structure is configured to catch a display panel. The tray 021 is provided with at least two catching structures, each of which can catch one display panel, and accordingly, the tray 021 may carry at least two display panels at the same time, so that the lighting jig 02 can detect at least two display panels at the same time, thus it is possible to increase the detection efficiency.

Further, in the lighting jig 02 provided by the embodiment of the present disclosure, the tray 021 is rotatable around the axis of the support frame 022 by means of the angle adjusting mechanism 023, and as an example, the tray 021 can make a 360-degree rotation about the axis of the support frame 022 by means of the angle adjusting mechanism 023, so that the staff can detect the display panel from different perspectives without changing his/her own position. For example, to improve the rigidity of the lighting jig 02 so as to ensure the reliability of the rotation of the tray 021 around the axis of the support frame 022, as shown in FIG. 3, the lighting jig 02 further includes a support bar 026, one end of which is fixedly connected to the tray 021 and the other end of which is fixedly connected to the lateral side of the support frame 022, and referring to FIG. 3, the other end of the support bar 026 is fixedly connected to the lateral side of the second cylindrical structure 0222 of the support frame 022.

As an example, referring to FIG. 6, which illustrates a front view of a tray 021 provided in the embodiment shown in FIG. 3, and referring to FIG. 6, the tray 021 includes at least two catching structures 0211 provided on the carrying surface W, configured to carry the display panel, of the tray, such a catching structure is configured to catch the display panel. Each of the catching structures 0211 includes at least two stoppers, and the stoppers include a stationary stopper and a movable stopper.

For example, as shown in FIG. 6, the catching structure includes two stationary stoppers 02111 and one movable stopper 02112, length directions of the two stationary stoppers 02111 are perpendicular to each other, and the length direction of the movable stopper is perpendicular to the length direction of one of the stationary stoppers 02111.

FIG. 6 illustrates by taking the example that two catching structures 0211 are provided on the carrying surface W. The provision of the movable stopper 02112 enables the lighting jig 02 to detect display panels of different sizes, and each of the stationary stoppers 02111 may be fixedly provided on the carrying surface W of the tray 021 by screws (not shown in FIG. 6). As shown in FIG. 6, any adjacent two catching structures 0211 may share one stationary stopper 02111, thus it is possible to reduce the number of the stationary stoppers 02111 which is used to form the catching structure 0211 on the tray 021. And in the embodiment of the present disclosure, in order to prevent the stoppers (including the stationary stoppers 02111 and the movable stopper 02112) from damaging the edge of the display panel, the location, being in contact with the display panel, of the stopper of each catching structure 0211 is provided with a rubber pad 02113.

For example, as shown in FIG. 6, the carrying surface W of the tray 021 is provided thereon with a slide rail 02114 along which the movable stopper 02112 is movable, so as to adjust the region defined by the stopper for the adaption to display panels of different sizes. The movable stopper 02112 is provided with a fourth screw hole (not shown in FIG. 6), the bottom of the slide rail 02114 is provided with a through hole (not shown in FIG. 6) extending along the thickness direction of the tray 021, the third bolt can pass through the fourth screw hole of the movable stopper 02112 and the through hole at the bottom of the slide rail 02114 so as to connect the slide rail 02114 with the movable stopper 02112.

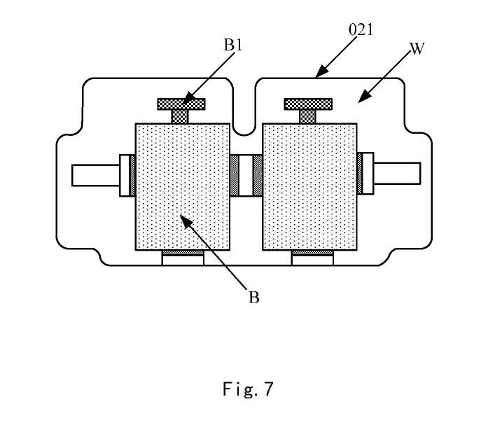

For example, FIG. 7 is a front view of a tray 021 carrying a display panel provided in the embodiment shown in FIG. 3, referring to FIG. 7, the carrying surface W of the tray 021 carries two display panels B, and each display panel B is disposed in a region defined by one catching structure, and each display panel B is provided with a circuit board B1 which may be a flexible printed circuit, the circuit board B1 is provided with a connector interface through which the display panel B can be applied with a signal, so that the display panel B is lighted up, and then detection is performed upon the display panel B.

In summary, the lighting jig provided by the embodiments of the present disclosure includes a tray, a support frame and an angle adjusting mechanism, and the tray is in a movable connection with the support frame by means of the angle adjusting mechanism; and the tray is configured to carry a display panel, and the support frame is configured to support the tray. Due to the movable connection of the tray with the support frame by means of the angle adjusting mechanism, it is possible to adjust the angle of the tray by using the angle adjusting mechanism without requiring the staffs to change their positions. In addition, such a lighting jig can be further provided with a height adjustment mechanism so as to eliminate errors brought by the staffs of different heights in the detection result. Therefore, the lighting jig provided by the embodiments of present disclosure solves the problem that the current detection process of the display panel is complicated, and achieves a beneficial effect of simplifying the detection process of the display panel.

It is apparent to those skilled in the art to make various modifications and variations to the present disclosure without departing from the spirit and scope of the present disclosure. In this way, if these modifications and variations belong to the scope of the claims of the present disclosure and their equivalents, then the present disclosure is intended to cover these modifications and variations.

What are described above is related to the illustrative embodiments of the disclosure only and not limitative to the scope of the disclosure; the scopes of the disclosure are defined by the accompanying claims.

This application claims the benefit of Chinese Patent Application No. 201520837468.6, filed on Oct. 26, 2015, which is hereby entirely incorporated by reference as a part of the present application.

1. A lighting jig, comprising a tray, a support frame and an angle adjusting mechanism, wherein the tray is in a movable connection with the support frame by means of the angle adjusting mechanism, the tray is configured to carry a display panel, and the support frame is configured to support the tray.

2. The lighting jig according to claim 1, wherein the angle adjusting mechanism comprises a connecting rod and a sphere which is fixedly connected with an end of the connecting rod, the other end of the connecting rod is connected with the tray, a concave is provided in the support frame, the sphere is provided within the concave and contacts an inner wall of the concave, and the tray is rotatable around the support frame.

3. The lighting jig according to claim 2, further comprising a lock mechanism located at the support frame, wherein in a case that the lock mechanism is released, the sphere is configured to be able to move in the concave; and in a case that the lock mechanism is locked, and the sphere is configured to be fixed in the concave.

4. The lighting jig according to claim 3, wherein the lock mechanism comprises at least two first bolts, the support frame comprises a columnar structure, a lateral side of the support frame is provided with at least two first screw holes communicating with the concave, and each of the first bolts is configured to be able to pass through one of the first screw holes to fix the sphere.

5. The lighting jig according to claim 4, wherein in the case that the lock mechanism is locked, movement directions of at least two of the first bolts are different from each other.

6. The lighting jig according to claim 2, wherein the concave is a concave with a curved surface.

7. The lighting jig according to claim 6, wherein the support frame comprises a first cylindrical structure and a second cylindrical structure, a cavity is provided in the first cylindrical structure, the second cylindrical structure is provided at least partially within the cavity, one bottom surface of the second cylindrical structure is provided within the cavity, and the other bottom surface of the second cylindrical structure is provided with the concave.

8. The lighting jig according to claim 6, further comprising a height adjusting mechanism, wherein the height adjusting mechanism is provided at the support frame for adjustment of a height of the support frame.

9. The lighting jig according to claim 8, wherein the height adjusting mechanism comprises a second bolt, at least two second screw holes are provided at a lateral side of the second cylindrical structure in a height direction of the support frame, a third screw hole is provided at a lateral side of the first cylindrical structure, and the second bolt is configured to be able to pass through the third screw hole and one of the second screw holes sequentially, so as to fixedly connect the first cylindrical structure and the second cylindrical structure.

10. The lighting jig according to claim 9, wherein extending directions of the second screw holes and the third screw hole are orthogonal to the height direction of the support frame.

11. The lighting jig according to claim 7, wherein a carrying surface, configured for carrying the display panel, of the tray is provided with a catching structure configured for catching the display panel.

12. The lighting jig according to claim 11, wherein the catching structure comprises at least two stoppers, and the stoppers comprise a stationary stopper and a movable stopper.

13. The lighting jig according to claim 12, wherein the catching structure comprises two stationary stoppers and one movable stopper, and length directions of the two stationary stoppers are perpendicular to each other, and a length direction of the movable stopper is perpendicular to a length direction of one of the stationary stoppers.

14. The lighting jig according to claim 13, wherein any adjacent two catching structures share one of the stationary stoppers.

15. The lighting jig according to claim 12, wherein each of the stationary stoppers and the movable stopper is provided, at a location which is configured to be in contact with the display panel, with a rubber pad.

16. The lighting jig according to claim 12, wherein the carrying surface is provided with a slide rail along which the movable stopper is movable.

17. The lighting jig according to claim 16, further comprising a third bolt, wherein the movable stopper is provided with a fourth screw hole, a bottom of the slide rail is provided with a through hole extending along a thickness direction of the tray, and the third bolt is able to pass through the fourth screw hole and the through hole to connect the slide rail and the movable stopper.

18. The lighting jig according to claim 16, further comprising a support bar, wherein one end of the support bar is fixedly connected to the tray, and the other end is fixedly connected to a lateral side of the support frame.

19. The lighting jig according to claim 2, wherein the sphere is a rigid sphere, and the connecting rod is integral with the sphere.

20. The lighting jig according to claim 3, wherein the concave is a concave with a curved surface
